(19) United States
(12) Patent Application Publication
(10) Pub. No.: US 2018/0056722 A1
(43) Pub. Date: Mar. 1, 2018

(54) TIRE COMPRISING A KNITTED FABRIC AND REINFORCING ELEMENTS

(71) Applicant: COMPAGNIE GENERALE DES ETABLISSEMENTS MICHELIN, CLERMONT-FERRAND (FR)

(72) Inventors: BASTIEN LIMOZIN, Clermont-Ferrand (FR); SÉBASTIEN RIGO, Clermont-Ferrand (FR); LAURENT BUCHER, Clermont-Ferrand (FR)

(21) Appl. No.: 15/554,490

(22) PCT Filed: Feb. 25, 2016
(86) PCT No.: PCT/EP2016/054016

§ 371 Date: Aug. 30, 2017

(30) Foreign Application Priority Data
Mar. 4, 2015 (FR) 1551807

(51) Int. Cl. B60C 9/18

(52) U.S. Cl. CPC B60C 9/1807; B60C 2200/06

(57) ABSTRACT

A reinforcing assembly for a tire includes a knit and a plurality of reinforcing elements. The knit includes a right side and a wrong side. The reinforcing elements extend parallel to one another and each criss-cross the knit over at least a portion of the knit. The knit is arranged in such a way that the right side is positioned radially outside relative to the wrong side.

The invention relates to a tire comprising a set of a knit and of reinforcing elements, to the use of such an assembly in a tire, and to a method of manufacturing such a tire.

The invention applies to any type of vehicle but is preferably intended for vehicles selected from vans, heavy vehicles such as “heavy-duty vehicles”, i.e. underground trains, buses, heavy road transport vehicles (lorries, tractors, trailers), off-road vehicles, agricultural or construction plant machinery, aircraft, and other transport or handling vehicles.

A tire comprising a carcass reinforcement that is anchored in two beads and surmounted radially by a crown reinforcement that is itself surmounted by a tread that is joined to the beads by two sidewalls is known from the prior art.

The carcass reinforcement comprises one or more carcass plies. Of the multiple functions of the carcass reinforcement, one is to protect the crown and the sidewalls from puncturing. It is known practice to significantly increase the strength of the crown by using several carcass plies, for example two carcass plies. Each carcass ply comprises reinforcing elements substantially parallel to one another and embedded in an elastomer matrix and comprising, depending on the embodiments, multi-filament strands comprising several metallic elementary monofilaments or else metallic monofilaments.

The crown reinforcement comprises a working reinforcement. The crown reinforcement may potentially comprise, in addition to the working reinforcement, a protective reinforcement arranged radially between the tread and the working reinforcement, and a hooping reinforcement interposed radially between the protective reinforcement and the working reinforcement. The protective reinforcement is intended to protect the working reinforcement and the carcass reinforcement from external attack, notably from puncturing. The working reinforcement comprises metallic reinforcing elements substantially parallel to one another and embedded in an elastomer matrix.

For this purpose, the protective reinforcement comprises a protective ply arranged above the working reinforcement so as to limit puncturing. The protective ply comprises reinforcing elements substantially parallel to one another and embedded in an elastomer matrix. These reinforcing elements comprise, depending on the embodiment, multi-filament strands comprising several metallic elementary monofilaments or else metallic monofilaments.

In order to improve the puncture-resistance of the tire, it is known practice to increase the thickness of the protective reinforcement and/or carcass. This increase in thickness is notably highly effective in the case of the carcass reinforcement.

However, although exhibiting satisfactory resistance to puncturing, the protective and/or carcass reinforcement of the prior art can still be improved. Specifically, increasing the thickness of the reinforcements leads to a significant increase in the mass of the tire and, in most cases, to an unacceptable increase in the rolling resistance.

Furthermore, when a puncture occurs there is a risk, on the one hand, that the tire will lose pressure and, on the other hand, that the metallic reinforcing elements of the working and/or carcass reinforcement will begin to corrode following the ingress of corrosive agents into and through the crown reinforcement.

It is an object of the invention to improve the puncture resistance of the tire.

To this end, one subject of the invention is a tire comprising an assembly comprising:
a knit comprising a right side and a wrong side and
a plurality of reinforcing elements,
   in which the reinforcing elements extend parallel to one another and each criss-cross the knit over at least a portion of the knit and in which the knit is arranged in such a way that the right side is radially on the outside with reference to the wrong side of the knit.

By definition, a knit is a reinforcing element comprising stitches. Each stitch comprises a loop interlaced with another loop. Thus, a distinction is made between a knit which is a textile made up of stitches and a woven fabric which is a textile comprising weft filamentary elements and warp filamentary elements, the weft filamentary elements being substantially parallel to one another and the warp filamentary elements likewise being substantially parallel to one another.

A distinction is made between weft-knitted knits and warp-knitted knits. In weft knits the stitches are essentially formed in the direction in which the loops of one and the same row are arranged next to one another (across the width of the knit). In warp knits the stitches are essentially formed in the direction in which the loops of one and the same column (wale) are arranged next to one another (along the length of the knit).

There are different constructions. A construction means the way in which the filamentary elements that form a repeating pattern in the knit are interlaced. Constructions include, nonlimitingly, jersey, welted jersey, 1×1 rib, polka rib, interlocked rib, moss stitch in the case of weft knits and locknit, and atlas in the case of warp knits.

A crossover is defined as being a point of contact between the reinforcing element and the knit.

Thanks to the structure of the tire in which the reinforcing elements criss-cross with the knit, the tire has improved resistance to puncturing at the locations at which this assembly is arranged. What happens is that the stitches of the knit are held together by the reinforcing elements and vice versa so that under the effect of an indenter, the stitches of the knit and the reinforcing elements move apart from one another very little, if at all, affording significant resistance to puncturing.

According to one embodiment, the knit comprises:
columns of loops, the loops of one and the same column being arranged one after the other substantially in an overall direction referred to as the main direction,
rows of loops, the loops of one and the same row being arranged one beside the other substantially in an overall direction referred to as the transverse direction;
   and in which each reinforcing element extends substantially in the main overall direction or the transverse overall direction.

For preference, the knit is made up of one or more filamentary elements of a material selected from a polyester, a polyamide, a polyketone, a polyvinyl alcohol, a cellulose, a mineral fibre, a natural fibre, an elastomeric material or a mixture of these materials.

Mention may be made, among polyesters, for example of PET (polyethylene terephthalate), PEN (polyethylene naphthalate), PBT (polybutylene terephthalate), PBN (polybutylene naphthalate), PPT (polypropylene terephthalate), and PPN (polypropylene naphthalate).

Mention may be made, among polyamides, of aliphatic polyamides such as polyamides 4-6, 6, 6-6 (nylon), 11 or 12 and aromatic polyamides such as aramid.

In one embodiment, each reinforcing element is a filamentary element comprising at least one multifilament strand comprising several elementary monofilaments and in which each elementary monofilament is made from a metallic material and/or a textile material.

In another embodiment, each reinforcing element is a filamentary element made up of a metallic monofilament.

A filamentary element means any longilinear element of great length relative to its cross section, whatever the shape of the latter, for example circular, oblong, rectangular or square, or even flat, it being possible for this filamentary element to be twisted or wavy, for example. When it is circular, its diameter is preferably less than 5 mm, more preferentially in a range from 100 μm to 1.2 mm.

For example, each multifilament strand is a textile plied yarn comprising several textile multifilament fibres plied together, a textile cord comprising several multifilament textile fibres, a metallic cord comprising several metallic monofilaments or an assembly comprising several textile or metallic cords then referred to as plied yarns.

By definition, a metallic material means that each metallic monofilament is made up predominantly (that is to say more than 50% of its weight) or entirely (100% of its weight) of a metallic material. The metallic material is preferably steel, more preferentially perlitic (or ferritic-perlitic) carbon steel advantageously comprising between 0.4% and 1.2% by weight of carbon.

Advantageously, each textile multifilament strand comprises between 20 and 1000 elementary monofilaments, preferably between 50 and 500 and more preferably between 70 and 300 elementary monofilaments. Such a number of elementary monofilaments makes it possible to ensure sufficient resistance to puncturing.

Advantageously, the diameter of each elementary monofilament ranges from 10 μm to 100 μm, preferably from 10 μm to 50 μm and more preferably from 12 μm to 30 μm. Such a diameter makes it possible to obtain an assembly comprising a knit that is relatively flexible and therefore compatible with use in a tire.

According to one embodiment, each reinforcing element criss-crosses with loops of one and the same column and/or with inter-loop elements of two distinct columns of loops, an inter-loop element connecting two loops belonging to two distinct columns of loops. For preference, the two distinct columns of loops are consecutive columns.

In one embodiment, each inter-loop element connects two loops belonging to one and the same row.

In another embodiment, each inter-loop element connects two loops belonging to two distinct rows, preferably consecutive.

Advantageously, a reinforcing element criss-crosses with at least one loop in each column every f columns and/or with at least one inter-loop element of each pair of consecutive columns of loops every f pairs of consecutive columns of loops.

Thus, in a preferred embodiment in which f=1, a reinforcing element criss-crosses with at least one loop in each column and/or with at least one inter-loop element of each pair of consecutive columns of loops. In another embodiment in which f=2, a reinforcing element criss-crosses with at least one loop in each column, in every second column, and/or with at least one inter-loop element of each pair of consecutive columns of loops, every second pair of columns.

For preference, a reinforcing element criss-crosses with each loop of one and the same column and/or with each inter-loop element of two consecutive columns of loops.

In one embodiment, the reinforcing elements criss-cross in phase with the loops of one and the same row and/or with the inter-loop elements of loops of one and the same row.

“The reinforcing elements criss-cross in phase” with the loops of one and the same row and/or with the inter-loop elements of loops of one and the same row means that the reinforcing elements criss-cross in the same way with the loops and/or the inter-loop elements of the knit, which means to say that, in the case of a row, they cross the loops and/or the inter-loops by passing over the same face (side) of the knit (wrong side or right side).

Specifically, a knit comprises two sides which are well known to and distinguishable by a person skilled in the art. Thus, a knit comprises a wrong side and a right side. The right side is also known as the front. The wrong side is also known as the back. Such sides are notably defined in standard NF EN 14971

Thus, standard NF EN 14971 defines the right side as being the side of the knit made up mainly of face stitches, namely of stitches intermingled in the knit in such a way that the legs pass over the needle loop formed in the same column of the previous row. Standard NF EN 14971 defines the wrong side as being the side of the knit made up mainly of reverse stitches, namely stitches intermingled in the knit in such a way that the loop (also referred to as the needle loop of the stitch) and the inter-loop element (also referred to as the sinker loop of the stitch) and the underlaps in warp knitting, pass over the legs of the stitches formed in the same column of the previous row and of the next row.

In another embodiment, the reinforcing elements criss-cross in phase-opposition with the loops of one and the same row and/or with the inter-loop elements of loops of one and the same row.

The expression “the reinforcing elements criss-cross in phase-opposition” with the loops of one and the same row and/or with the inter-loop elements of loops of one and the same row is defined in contrast with the expression “the reinforcing elements criss-cross in phase”. That means that two consecutive reinforcing elements do not criss-cross in the same way with the loops and/or inter-loop elements of the knit, namely that, in the case of a row, two consecutive reinforcing elements cross the loops and/or the inter-loop elements by passing over opposite sides of the knit (wrong side and right side).

In one particularly preferred embodiment, the knit comprising a wrong side and a right side, the reinforcing elements criss-cross with the loops of one and the same column by passing from the right side to the wrong side every k rows and/or the inter-loop elements of two consecutive columns of loops by passing from the right side to the wrong side every k rows.

In one preferred embodiment, k=2. In other words, that means that, in this embodiment, the reinforcing elements criss-cross with the loops of one and the same column by passing alternatively over the wrong side and over the right side, and/or the inter-loop elements of two consecutive columns of loops by passing alternatively over the wrong side and over the right side.

Advantageously, the knit has a right side and a wrong side and is arranged in such a way that the right side is radially on the outside with reference to the wrong side of the knit.

Advantageously, the knit is coated with a layer of a tackifying adhesive. The adhesive used is for example of the RFL (resorcinol-formaldehyde-latex) type or, for example, as described in the publications WO2013017421, WO2013017422, WO02013017423.

In one preferred embodiment, the tire comprises a crown surmounted by a tread, two sidewalls, two beads, each sidewall connecting each bead to the crown, a carcass reinforcement that is anchored in each of the beads and extends through the sidewalls towards the crown, a crown reinforcement that is radially interposed between the carcass reinforcement and the tread, the crown reinforcement comprising the assembly.

In one embodiment, the crown reinforcement is made up of a working reinforcement comprising two working plies. In this embodiment, the crown reinforcement has no protective reinforcement, and this means that the tire can be lightened.

Optionally, each working ply comprises working reinforcing elements that form an angle ranging from 15° to 40°, preferably ranging from 20° to 30°, with the circumferential direction of the tire.

Advantageously, the working reinforcing elements are crossed from one working ply to the other. More advantageously still, the angle of the reinforcing elements of each working ply is the same. Thus, if the angle of the reinforcing elements with the circumferential direction of the tire in one working ply is equal to +A°, then the angle of the reinforcing elements with the circumferential direction of the tire of the other working ply is equal to −A°.

In a first alternative form of this first embodiment, at least one of the working plies comprises the assembly, the reinforcing elements of the assembly forming the working reinforcing elements of the working ply. Thus, the reinforcing elements of at least one working ply provide a way of combating puncturing while at the same time performing their usual function.

In a second alternative form of this first embodiment, each working ply comprises an assembly, the reinforcing elements of each assembly forming the working reinforcing elements of each working ply. In this second alternative form, the reinforcing elements of each working ply provide a way of combating puncturing while at the same time performing their usual function.

In another embodiment, the crown reinforcement comprises a working reinforcement comprising two working plies and a protective reinforcement comprising a protective ply.

Optionally, each working ply comprises working reinforcing elements that form an angle ranging from 15° to 40°, preferably ranging from 20° to 30°, with the circumferential direction of the tire, and the protective ply comprises protective reinforcing elements that form an angle ranging from 5° to 35°, preferably ranging from 10° to 30°, with the circumferential direction of the tire.

Advantageously, the working reinforcing elements are crossed from one working ply to the other. More advantageously still, the angle of the reinforcing elements of each working ply is the same. Thus, if the angle of the reinforcing elements with the circumferential direction of the tire in one working ply is equal to +A°, then the angle of the reinforcing elements with the circumferential direction of the tire of the other working ply is equal to −A°.

In a first alternative form of this second embodiment, the protective ply comprises the assembly, the reinforcing elements of the assembly forming the protective reinforcing elements of the protective ply. The protective ply provides a way of effectively combating puncturing.

In a second alternative form of this second embodiment, at least one of the working plies comprises the assembly, the reinforcing elements of the assembly forming the working reinforcing elements of the working ply. Thus, in addition to the protective ply, the reinforcing elements of at least one working ply provide a way of combating puncturing while at the same time performing their usual function.

In a third alternative form of this second embodiment, each working ply comprises an assembly, the reinforcing elements of each assembly forming the working reinforcing elements of each working ply. In addition to the protective ply, in this third alternative form, the reinforcing elements of each working ply provide a way of combating puncturing while at the same time performing their usual function.

In certain embodiments, the protective ply is radially interposed between the working plies.

In other embodiments, the protective ply is radially interposed between the tread and the working reinforcement.

For preference, the assembly forms a continuous strip in the circumferential direction of the tire.

In another embodiment, the carcass reinforcement comprises the assembly.

The invention thus proposes weft-filling a reinforcing ply of a tire to make it possible to improve its puncture-resistance capability

The invention also relates to the use, by way of a tire reinforcing element, of an assembly comprising
a knit comprising a right side and a wrong side and
a plurality of reinforcing elements,
   in which the reinforcing elements extend parallel to one another and each criss-cross the knit over at least a portion of the knit, and in which the knit is intended to be arranged in such a way that the right side is radially on the outside with reference to the wrong side of the knit.

Another subject of the invention is a method of manufacturing a tire as described hereinabove, in which the assembly is embedded in at least one elastomer matrix.

For preference, the elastomer is a diene elastomer.

An elastomer or rubber (the two terms being synonyms) of the “diene” type is intended to mean, generally, an elastomer resulting at least in part (i.e., a homopolymer or a copolymer) from diene monomers (monomers bearing two conjugated or unconjugated carbon-carbon double bonds).

Particularly preferably, the diene elastomer is selected from the group of diene elastomers consisting of polybutadienes (BRs), synthetic polyisoprenes (IRs), natural rubber (NR), butadiene copolymers, isoprene copolymers and the mixtures of these elastomers. Such copolymers are more preferentially selected from the group consisting of butadiene/stirene copolymers (SBRs), isoprene/butadiene copolymers (BIRs), isoprene/stirene copolymers (SIRs), isoprene/butadiene/stirene copolymers (SBIRs) and the mixtures of such copolymers.

In one embodiment, the tire is for industrial vehicles selected from vans, heavy vehicles such as “heavy-duty vehicles”—i.e. underground trains, buses, road haulage vehicles (lorries, tractors, trailers), off-road vehicles, agricultural vehicles or civil engineering plant, aircraft, other transport or handling vehicles.

The invention will be better understood in the light of the following description which is given merely by way of indication and which is not intended to restrict the said invention, accompanied by the figures below:

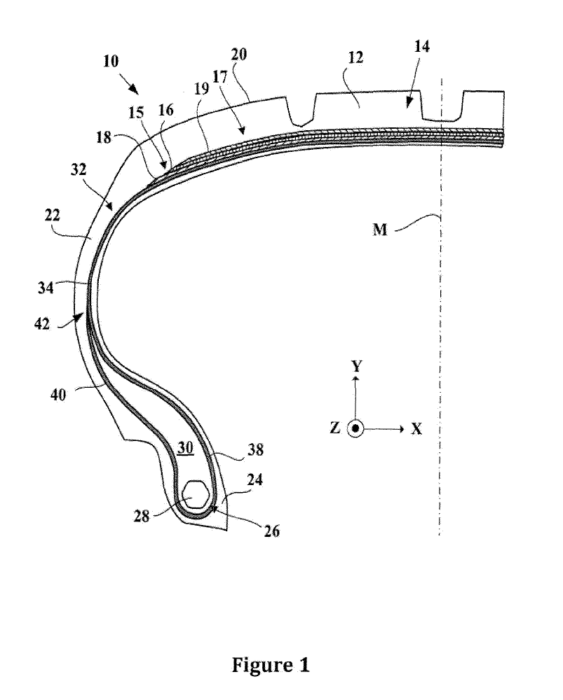

FIG. 1 is a view in cross section of a tire according to a first embodiment of the invention comprising an assembly;

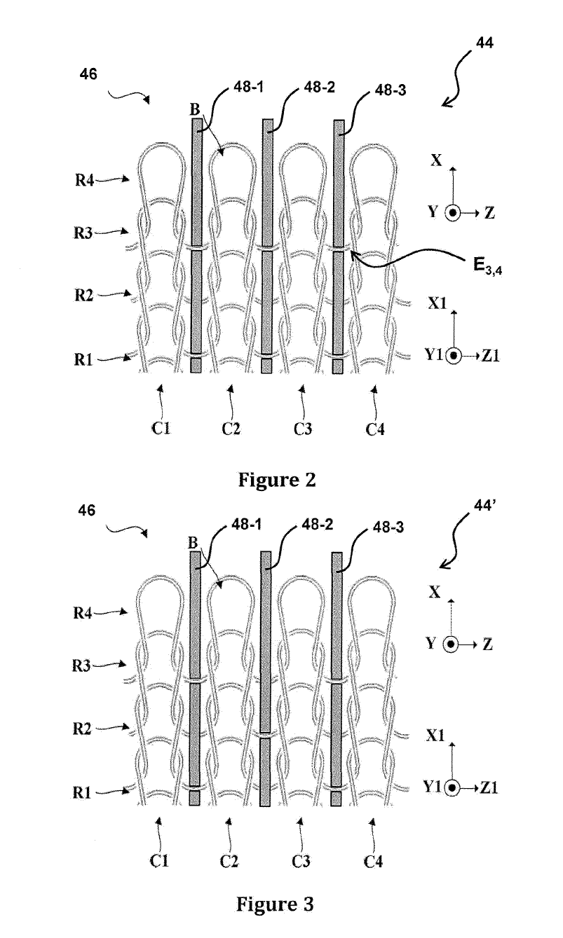

FIG. 2 is a schematic view of the details of an assembly according to a first embodiment of the invention comprising a weft knit and reinforcing elements which criss-cross in phase with the inter-loop elements of the knit;

FIG. 3 is a schematic depiction of an assembly according to a second embodiment of the invention comprising a weft knit and reinforcing elements which criss-cross in phase-opposition with the inter-loop elements of the knit;

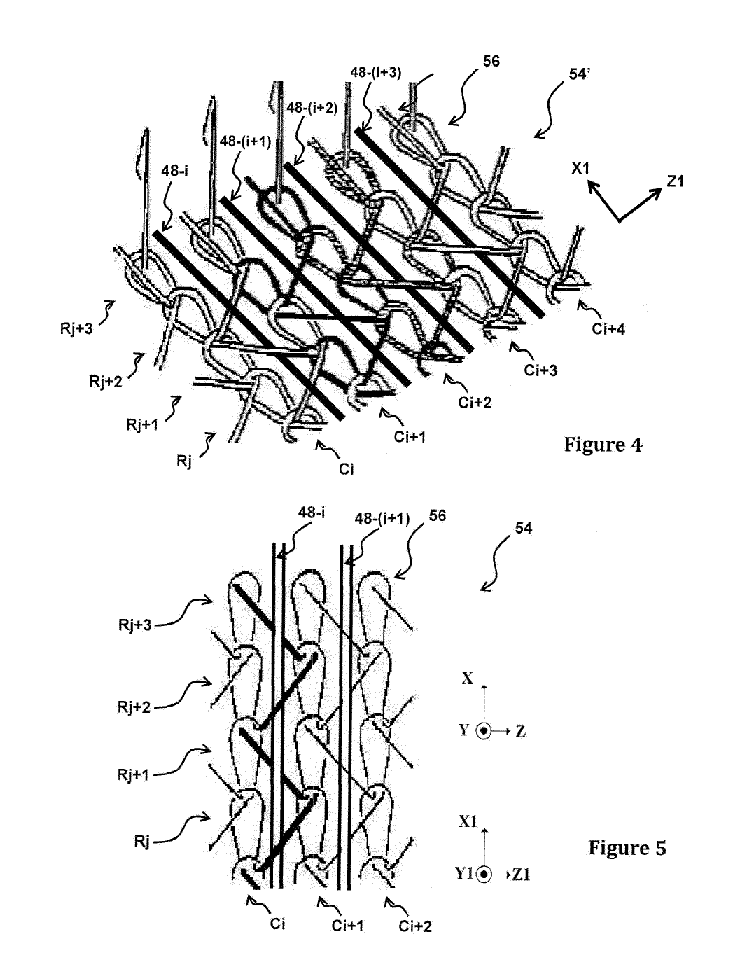

FIG. 4 is a schematic depiction of an assembly according to a third embodiment of the invention comprising a warp knit and reinforcing elements which criss-cross in phase with the inter-loop elements of the knit;

FIG. 5 is a schematic depiction of an assembly according to a fourth embodiment of the invention comprising a warp knit and reinforcing elements which criss-cross in phase-opposition with the inter-loop elements of the knit;

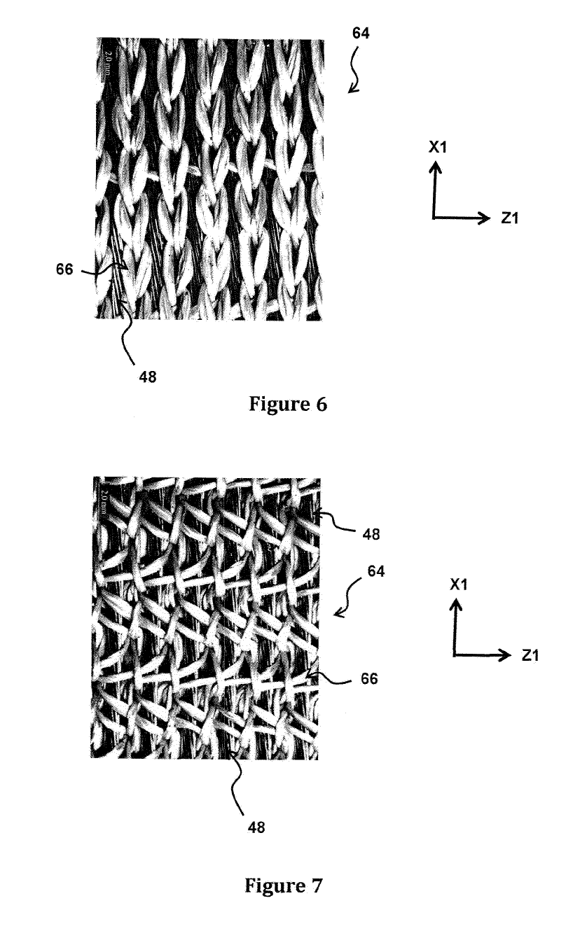

FIG. 6 is a photograph of a right side of an assembly according to a fifth embodiment of the invention;

FIG. 7 is a photograph of a wrong side of the assembly of FIG. 6; and

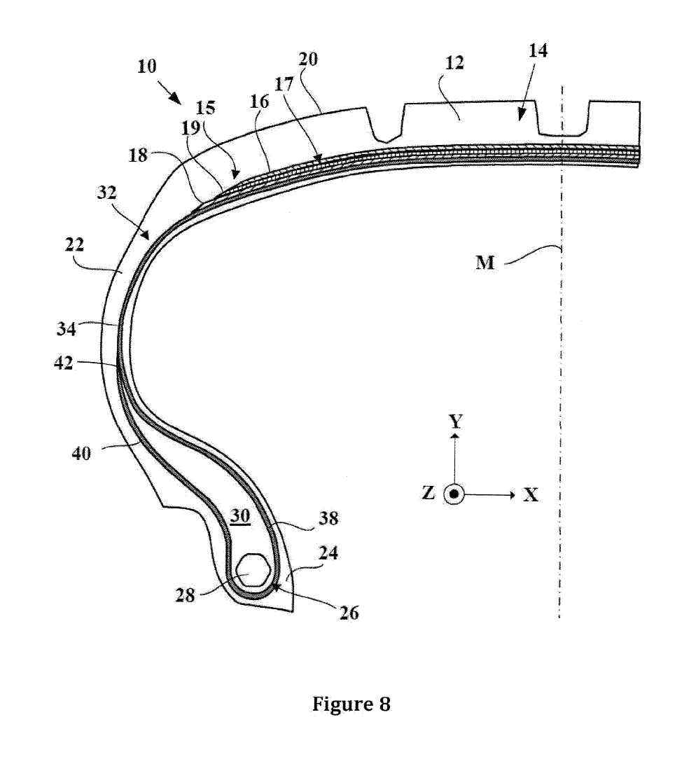

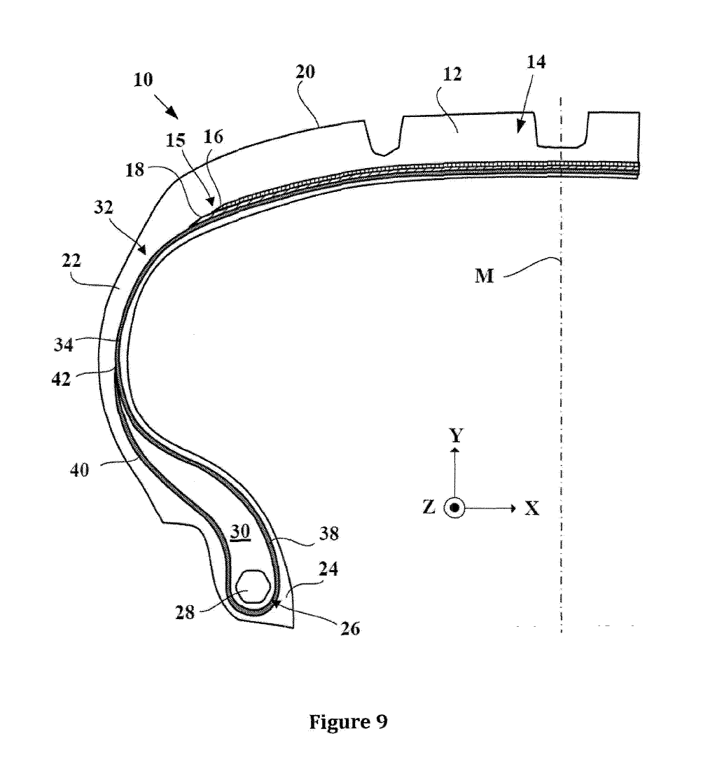

FIGS. 8 and 9 are views similar to that of FIG. 1 of tires respectively according to second and third embodiments.

In the various figures, analogous elements are denoted by identical references. Furthermore, in order to present a view that makes the invention easier to understand, the various elements are not necessarily drawn to scale.

In the following description, when the term “radial” is used, it is appropriate to make a distinction between several different uses of the word by a person skilled in the art.

Firstly, the expression refers to a radius of the tire. It is in that sense that a point A is said to be “radially inside” a point B (or “radially on the inside of” the point B) if it is closer to the axis of rotation of the tire than is the point B. Conversely, a point C is said to be “radially outside” a point D (or “radially on the outside of” the point D) if it is further from the axis of rotation of the tire than is the point D. Progress “radially inwards (or outwards)” will mean progress towards smaller (or larger) radii.

It is this sense of the word that applies also when radial distances are being discussed.

On the other hand, a reinforcing element or a reinforcement is said to be “radial” when the reinforcing element or the reinforcing elements of the reinforcement make an angle greater than or equal to 65° and less than or equal to 90° with the circumferential direction.

An “axial” direction is a direction parallel to the axis of rotation of the tire. A point E is said to be “axially inside” a point F (or “axially on the inside of” the point F) if it is closer to the median plane of the tire than is the point F. Conversely, a point G is said to be “axially outside” a point H (or “axially on the outside of” the point H) if it is further from the median plane of the tire than is the point H.

The “median plane” M of the tire is the plane which is normal to the axis of rotation of the tire and which is situated equidistantly from the annular reinforcing structures of each bead.

A “circumferential” direction is a direction which is perpendicular both to a radius of the tire and to the axial direction.

Furthermore, any range of values denoted by the expression “between a and b” represents the range of values extending from more than a to less than b (in other words excluding the limits a and b), whereas any range of values denoted by the expression “from a to b” means the range of values extending from the limit “a” as far as the limit “b”, in other words including the strict limits “a” and “b”.

### DETAILED DESCRIPTION OF EXAMPLES OF TIRES ACCORDING TO THE INVENTION

A frame of reference X, Y, Z corresponding to the usual respectively axial (X), radial (Y) and circumferential (Z) directions of a tire has been depicted in the figures.

FIG. 1 depicts a tire according to the invention and denoted by the general reference 10. The tire 10 is substantially of revolution about the axis X. The tire 10 here is intended for industrial vehicles, for example vans, heavy vehicles such as “heavy-duty vehicles”—i.e. underground trains, buses, road haulage vehicles (lorries, tractors, trailers), off-road vehicles, agricultural vehicles or civil engineering plant, aircraft, other transport or handling vehicles.

The tire 10 comprises a crown 12 comprising a crown reinforcement 14 comprising a working reinforcement 15 comprising two working plies 16, 18 of reinforcing elements and a protective reinforcement 17 comprising a protective ply 19. The crown reinforcement 14 is surmounted by a tread 20. Here, the protective reinforcement 17, here the protective ply 19, is interposed radially between the working reinforcement 15 and the tread 20.

Two sidewalls 22 extend the crown 12 radially inwards. The tire 10 further comprises two beads 24 radially on the inside of the sidewalls 22 and each comprising an annular reinforcing structure 26, in this instance a bead wire 28, surmounted by a mass of filling rubber 30, and also a radial carcass reinforcement 32. The carcass reinforcement 32 is surmounted radially by the crown reinforcement 14.

The carcass reinforcement 32 preferably comprises a single carcass ply 34 of radial textile reinforcing elements, the ply 34 being anchored in each of the beads 24 by being turned up around the bead wire 28 so as to form within each bead 24 a main strand 38 extending from the beads 24 through the sidewalls 22 to the crown 12 and a turnup 40, the radially outer end 42 of the turnup 40 here being substantially midway up the height of the tire.

The carcass reinforcement 32 thus extends from the beads 24 through the sidewalls 22 to the crown 12. As an alternative, the radial reinforcing elements of the carcass reinforcement 32 are metallic.

The working plies 16, 18 comprise metal or textile reinforcing elements forming an angle of from 15° to 40°, preferably ranging from 20° to 30° and here equal to 26° with the circumferential direction of the tire. The working reinforcing elements, in this instance made of metal, are crossed from one working ply to the other.

The protective ply 19 comprises metallic or textile protective reinforcing elements, in this instance metallic ones, that form an angle ranging from 5° to 35°, preferably ranging from 10° to 30°, with the circumferential direction of the tire.

Each working ply 16, 18, protective ply 19 and carcass ply 34 comprises an elastomer matrix in which the reinforcing elements of the corresponding ply are embedded. An elastomer (or rubber, the two terms being synonymous) matrix means a matrix comprising at least one elastomer. The compositions of the elastomer matrices of the working plies 16, 18, protective ply 19 and carcass ply 34 are conventional compositions for the calendering of reinforcing elements conventionally comprising a diene elastomer, for example natural rubber, a reinforcing filler, for example carbon black and/or silica, a crosslinking system, for example a vulcanizing system, preferably containing sulphur, stearic acid and zinc oxide, and possibly a vulcanization accelerant and/or retarder and/or various additives.

With reference to FIGS. 2 to 7, the crown reinforcement 14 comprises an assembly 44 described hereinbelow. Here, the protective ply comprises, by way of reinforcing element, the assembly 44 comprising a knit 46 and a plurality of reinforcing elements 48. The reinforcing elements 48 extend parallel to one another and each criss-cross the knit 46 over at least a portion of the knit 46. The reinforcing elements 48 of the assembly form the protective reinforcing elements of the protective ply 19.

Thus, such an assembly is more resistant to puncturing by virtue of the crossovers between the knit and the reinforcing elements. Specifically, the knit makes it possible to limit the separation between the reinforcing elements, and vice versa.

For preference, the knit 46 is made up of one or more filamentary elements of a material selected from a polyester, a polyamide, a polyketone, a polyvinyl alcohol, a cellulose, a mineral fibre, a natural fibre, an elastomeric material or a mixture of these materials.

Furthermore, each reinforcing element 48 is advantageously a filamentary element comprising at least one multifilament strand comprising several elementary monofilaments and in which each elementary monofilament is made from a metallic material and/or a textile material.

As depicted in FIGS. 2 to 5, the or each knit 46 comprises columns C1, C2, C3, C4 (Ci) of loops B and rows R1, R2, R3, R4 (Rj) of loops B. The loops B of one and the same column Ci are arranged one after another substantially in an overall direction referred to as the main direction X1. The loops B of one and the same row Rj are arranged one beside the other substantially in an overall direction referred to as the transverse direction Z1. A loop of a column Ci and of a row Rj is denoted Bi,j in the remainder of the description.

The main X1 and transverse Z1 directions of each knit 44 make, with respect to one another, an angle of between 75° and 105°, preferably between 85° and 95°. Here, the main X1 and transverse Z1 directions are substantially perpendicular to one another.

The transverse overall direction Z1 makes an angle at most equal to 10° with the circumferential direction Z of the tire 10 and in this instance an angle equal to 0°, the transverse overall direction Z1 of each knit 46 being substantially parallel to the circumferential direction Z of the tire. The main overall direction X1 of the knit 46 is substantially parallel to the radial direction X of the tire.

Advantageously, each reinforcing element 48 extends substantially in the main overall direction X1 or the transverse overall direction Z1.

For preference, each reinforcing element 48 extends substantially in the main overall direction X1, as illustrated in FIGS. 2 to 7. In that case, this assembly is also referred to as a column-filled knit, namely a knit which contains elements filled in over the entire length of the workpiece and held in place by the stitches of the basic construction.

Advantageously, each reinforcing element 48 criss-crosses with loops B of one and the same column Ci and/or with inter-loop elements E of two distinct columns of loops, in this instance consecutive columns Cᵢ, and Cᵢ₊₁. An inter-loop element E_{i,j} is defined as being the portion of a filamentary element of the knit connecting two loops belonging to two distinct columns i, j of loops, in this instance consecutive columns of loops.

In the case of a weft knit, this is the portion of filamentary element connecting two loops B_{i,j}, B_{i+1,j} of the same row Rⱼ belonging to two consecutive columns Cᵢ, Cᵢ₊₁.

In the case of a warp knit, this is the portion of filamentary element connecting two loops B_{i,j}, B_{i′,j′} belonging to two columns and to two rows that are distinct (i≠i′ and j≠j′). For preference, i′=i+1 and j′=j+1, which means to say that the two rows and the two columns are consecutive.

For preference, the assembly 44 comprises a plurality of reinforcing elements 48 arranged in such a way that a reinforcing element 48 criss-crosses with at least one loop B in each column every f column and/or with at least one inter-loop element E of each pair of consecutive columns of loops every f pairs of consecutive columns of loops, as illustrated in FIGS. 2 to 7.

For preference, f=1, which means to say that the assembly 44 comprises a plurality of reinforcing elements 48 arranged in such a way that each reinforcing element 48 criss-crosses with a loop B in each column and/or with an inter-loop element of each pair of consecutive columns of loops.

For preference, each reinforcing element 48 criss-crosses with each loop B of one and the same column and/or with each inter-loop element E of two consecutive columns of loops.

Having a comparable number of reinforcing elements and of columns of knit makes it possible to achieve a maximum density of reinforcing elements and a well-controlled separation between the reinforcing elements.

For preference, each reinforcing element 48 criss-crosses with the knit 46 on each row of the knit 46. Of course, each reinforcing element may criss-cross with the knit at regular intervals with the rows of the knit, this recurrence being chosen in such a way as to achieve predetermined mechanical properties for the assembly.

Advantageously, the reinforcing elements 48 criss-cross in phase with the loops of a row R of the knit and/or with the inter-loop elements of loops of a row R of the knit. As illustrated in FIGS. 2, 4, 6 and 7, the reinforcing elements 48 criss-cross in phase with all the inter-loop elements of loops of one and the same row R of the knit. Thus, with reference to these figures, considering the reinforcing elements 48-1, 48-2 and 48-3, these criss-cross in the same way with all loops B_{i,j} of one and the same row Rⱼ and/or with all the inter-loop elements E_{i,j} of loops of one and the same row Rⱼ. According to the definition given hereinabove, the reinforcing elements 48-1, 48-2 and 48-3 criss-cross on the same side of the knit with each inter-loop element E_{i,j} of one and the same row Rⱼ.

In an alternative form, the reinforcing element 48 criss-cross in phase-opposition with the loops of one and the same row R and/or with the inter-loop elements of loops of one and the same row R. As illustrated in FIGS. 3 and 5, considering two consecutive reinforcing elements 48-1 and 48-2, these do not criss-cross in the same way with two consecutive loops B_{i,j} and/or with two consecutive inter-loop elements E_{i,j} of the same row Rⱼ. According to the definition given hereinabove, the reinforcing elements 48-1 and 48-2 criss-cross on opposite sides of the knit with each inter-loop element E_{i,j} of one and the same row Rⱼ.

For preference, the or each knit 44 is a warp knit as illustrated in FIGS. 4 to 7. Nevertheless, weft knits are also conceivable, as illustrated in FIGS. 2 and 3. Any type of construction is possible for each knit 44.

Each knit 44 is produced using a knitting method conventional to those skilled in the art in this field.

Furthermore, the knit has a right side and a wrong side and is arranged in such a way that, according to the invention, the right side is radially on the outside with reference to the wrong side of the knit.

Each knit 44 is such that the reinforcing elements 48 criss-cross with the loops B of one and the same column Cᵢ by passing from the right side to the wrong side every k rows Rⱼ and/or with the inter-loop elements E of two consecutive columns Cᵢ, Cⱼ of loops by passing from the right side to the wrong side every k rows Rⱼ. Preferably, k=1.

FIGS. 2 and 3 illustrate two embodiments of assemblies 44 and 44′ according to the invention, in which the knit 46 is a weft knit made up of several filamentary elements. Only a portion of the assemblies is depicted, in which portion 4 columns and 4 rows of knit are illustrated.

In these two embodiments, each reinforcing element 48-i criss-crosses with the knit 46 between two consecutive columns Cᵢ, Cᵢ₊₁.

In this particular instance, each reinforcing element 48-i criss-crosses with the inter-loop elements E_{i,j}, of two consecutive columns of loops, these inter-loop elements E_{i,j}, connecting two loops belonging to the consecutive columns Cᵢ and Cᵢ₊₁.

In addition, each reinforcing element 48-i criss-crosses with inter-loop elements of each pair of consecutive columns of loops and with each inter-loop element of two consecutive columns of loops.

In addition, all the reinforcing elements criss-cross in phase with the inter-loop elements of loops of one and the same row.

Each knit 44 in FIGS. 2 and 3 is such that the reinforcing elements 48 criss-cross with the inter-loop elements E of two consecutive columns Cᵢ, Cⱼ of loops by passing from the right side to the wrong side at each row Rⱼ. In other words, that means that each reinforcing element 48-i criss-crosses on the wrong (or right) side of the inter-loop element E_{i,j} and on the right (or wrong) side of the inter-loop element E_{i,j+1} of the next row.

With reference to FIG. 2, the reinforcing element 48-1 criss-crosses:
behind the inter-loop element E_{2,3} of row R2,
in front of the inter-loop element E_{2,3} of row R3, and
behind the inter-loop element E_{2,3} of row R4.

This criss-crossing repeats for all the reinforcing elements, particularly for 48-2 and 48-3.

Thus, in the embodiment illustrated in FIG. 2, all the reinforcing elements 48 of the fabric of FIG. 2 criss-cross in phase with the inter-loop elements of loops of each row Rⱼ.

With reference to FIG. 3, the reinforcing element 48-2 criss-crosses:
in front of the inter-loop element E_{2,3} of row R2,
behind the inter-loop element E_{2,3} of row R3, and
in front of the inter-loop element E_{2,3} of row R4.

By contrast, each reinforcing element 48-1 and 48-3 criss-crosses:
behind the inter-loop element E_{1,2} and E_{3,4} of row R2,
in front of the inter-loop element E_{1,2} and E_{3,4} of row R3, and
behind the inter-loop element E_{1,2} and E_{3,4} of row R4.

Thus, in the embodiment illustrated in FIG. 3, pairs of reinforcing elements 48-i are in phase opposition, which means to say that, for each pair of consecutive reinforcing element 48-i, 48-j, the two reinforcing elements 48-i, 48-j criss-cross in phase-opposition with the inter-loop elements of loops of one and the same row Rⱼ.

Of course, in other alternative forms, each reinforcing element 48-i may criss-cross with the loops B or the inter-loop elements E_{i,j} at regular intervals of rows of the knit 46, for example every k rows, with k>2. Thus, each reinforcing element 48-i may criss-cross with the knit 46 in the following way in the case of reinforcing elements 48 that are in phase:
behind the inter-loop element E_{i,j} of the rows Rⱼ, Rⱼ₊ₖ, Rⱼ₊₂ₖ . . .
in front of the inter-loop element E_{i,j} of the rows Rⱼ₊₁, Rⱼ₊₁₊ₖ, Rⱼ₊₁₊₂ₖ . . .

In the case of reinforcing elements 48 in phase-opposition, each reinforcing element 48 may criss-cross with the knit 46 in the following way:
behind the inter-loop element E_{i,j} of the rows Rⱼ, Rⱼ₊ₖ, Rⱼ₊₂ₖ . . . in the case of the reinforcing elements 48-m,
in front of the inter-loop element E_{i+1,j+1} of the rows Rⱼ, Rⱼ₊ₖ, Rⱼ₊₂ₖ . . . in the case of the reinforcing elements 48-2m,
in front of the inter-loop element E_{i,j} of the rows Rⱼ₊₁, Rⱼ₊₁₊ₖ, Rⱼ₊₁₊₂ₖ . . . in the case of the reinforcing elements 48-m,
behind the inter-loop element E_{i+1,j+1} of the rows Rⱼ₊₁, Rⱼ₊₁₊ₖ, Rⱼ₊₁₊₂ₖ . . . in the case of the reinforcing elements 48-2m.

Thus, all the reinforcing elements 48 may criss-cross in phase or in phase opposition, with a certain recurrence.

FIGS. 4 and 5 illustrate two other embodiments of assemblies 54 and 54′ according to the invention, in which the knit 56 is a warp knit made up of several filamentary elements knitted together. Only a portion of the assemblies is depicted.

The knits are identical for the two embodiments illustrated. The knits are warp knits of jersey construction.

Unlike in the embodiments illustrated in FIGS. 2 and 3, each reinforcing element 48-i of the knits 56 in FIGS. 4 and 5 criss-crosses with the inter-loop elements E_{i,j} of two consecutive columns of loops, each inter-loop element E_{i,j} connecting two loops belonging to two consecutive columns of loops and belonging to two consecutive rows of loops. Thus, each inter-loop element E_{i,j} connects the loops B_{i,j} and B_{i+1,j+1}.

FIGS. 6 and 7 are photographs respectively of the right and wrong sides of one and the same assembly 64 according to a fifth embodiment of the invention. The knit 66 has been produced on a warp knitting machine said to be fully threaded, which means that all of the heddle hooks, each secured to a support known as a bar, has a filamentary element in its needle. The various filamentary elements are worked according to the following bar movement coding: Bar 1: 10/01//—Bar 2: 10/23//—Bar 3: 00//—Bar 4: 00/11/00/22/11/22//. In what follows, this coding is referred to as type 3 coding.

In the preceding embodiments, the knit is made up of several filamentary elements of textile material coated with a layer of tackifying adhesive of RFL type.

Each reinforcing element comprises a multifilament strand comprising several elementary monofilaments made of a metallic or textile material. In the case of the assemblies of FIGS. 2, 3, 4 and 5, each reinforcing element is made up of two textile multifilament strands wound around one another, for example made of aramid, of polyester or of nylon. In the case of FIGS. 6 and 7, each reinforcing element comprises, in this instance consists of, a cord of structure 3+9, each elementary monofilament being a metal wire having a diameter equal to 0.18 mm.

FIG. 8 depicts a tire according to a second embodiment of the invention. Unlike the tire according to the first embodiment, in the tire of FIG. 8, the protective ply 19 is interposed radially between the working plies 16, 18. In the alternative form depicted in FIG. 8, and just as with the tire according to the first embodiment, the protective ply 19 comprises the assembly, reinforcing elements 48 of the assembly forming the protective reinforcing elements of the protective ply 19. In another alternative form that has not been depicted, one of the working plies 16, 18, in this instance 16, comprises the assembly, the reinforcing elements of the assembly forming the working reinforcing elements of the working ply 16, 18. It could equally be the ply 18. In yet another alternative form, each working ply 16, 18 comprises an assembly, the reinforcing elements 48 of each assembly forming the working reinforcing elements of each working ply 16, 18.

FIG. 9 depicts a tire according to a third embodiment of the invention. Unlike the tire according to the first embodiment, in the tire of FIG. 9, the crown reinforcement 14 is made up of a working reinforcement 15 comprising two working plies. In other words, the crown reinforcement 14 has no protective reinforcement. In the alternative form depicted in FIG. 9, one of the working plies 16, 18, in this instance 16, comprises the assembly, the reinforcing elements 48 of the assembly forming the working reinforcing elements of the working ply 16. It could equally be the ply 18. In another possible, but not depicted, alternative form, each working ply 16, 18 comprises an assembly, the reinforcing elements 48 of each assembly forming the working reinforcing elements of each working ply 16, 18.

Comparative Tests

Tire plies according to the invention and a ply of a control tire T0 according to the prior art were compared.

The knits tested were manufactured to two different bar movement codings, a type 1 coding and a type 3 coding. The type 3 coding corresponds to the one described with reference to the fifth embodiment of the invention described hereinabove and illustrated in FIGS. 6 and 7. The type 1 coding is as follows: Bar 1: 10/01//—Bar 2: 00/11/00/33/22/33//—Bar 3: 00//—Bar 4: 22/11/22/00/11/00//.

The ply of tire T0 comprises an elastomer matrix in which are embedded metallic cords of structure 3+9, each metal filament having a diameter equal to 0.18 mm.

Each ply of each tire T1 to T6 according to the invention comprises an elastomer matrix in which is embedded a knit filled with reinforcing elements. Each reinforcing element is a filamentary element comprising a single multifilament strand comprising several elementary monofilaments and in which each elementary monofilament is made from a textile material. The textile material is either aramid or nylon. The protective ply is produced by skimming the assembly between two elastomer strips 1 mm in width. The knit may or may not be coated with a coat of tackifying adhesive of RFL type. The knit is produced using one of the two codings described hereinabove and a given stitch density. The stitch density is determined in accordance with standard NF EN 14971.

Table 1 below summarizes the various characteristics of the plies tested.

TABLE 1

| | | Reinforcing | | Density |
|---|---|---|---|---|
| Tire | Coding | elements | Coating | (stitches/cm) |
| T1 | 1 | aramid | RFL adhesive | 8.2 |
| T2 | 1 | aramid | RFL adhesive | 5.3 |
| T3 | 3 | aramid | RFL adhesive | 5.3 |
| T4 | 3 | Nylon | RFL adhesive | 5.3 |
| T5 | 1 | Nylon | RFL adhesive | 8.2 |
| T6 | 1 | aramid | — | 8.2 |

Puncture tests were carried out on each ply manufactured, during which tests each ply was exposed to an indenting tool which applied a set displacement load in such a way that the wrong side or the right side of the knit was exposed to the indenting tool. During the course of the tests, the plies were fixed to a rigid support and the indenting tool was fixed to a load cell. The indenting tool was a nail with a cylindrical and longitudinal body 4.5 mm in diameter and a head of conical shape with cone angle 30° and a flat end 1 mm in diameter. The indenting tool was moved into contact with the ply until the ply was punctured. The variation in the force applied to the ply as a function of the movement was measured.

The value of the puncturing force corresponds to the maximum load applied to the ply up to the point just before it becomes punctured. The puncture force values for the plies containing the assemblies tested are summarized in Table 2 below.

TABLE 2

| Tire | Puncture force (N) |
|---|---|
| T0 | 101.8 |

| | Puncture force (N) | Puncture force (N) |
|---|---|---|
| Tire | right side | wrong side |
| T1 | 388.4 | 343.5 |
| T2 | 314.4 | 253.8 |
| T3 | 413.4 | 336.3 |
| T4 | 305.7 | 256.9 |
| T5 | 273.8 | 257.1 |
| T6 | 344.4 | 339.0 |

It is noted that the ply of the tire according to the invention withstands a maximum puncture load that is far higher than the ply of the control tire. Specifically, the maximum puncture load is 2.5 to 4.1 times higher in the assemblies of the tires according to the invention (T1 to T6) as compared with the control T0.

Furthermore, it should also be noted that the direction in which the assembly is laid plays an essential role in the puncture tests. Specifically, the puncture forces are greater when the indenter comes into contact with the right side of the assembly.

The invention is not limited to the embodiments described above.

Specifically, the assembly formed by the knit filled with the reinforcing elements could be arranged in other locations in the tire than those described hereinabove, for example in the carcass reinforcement, in the hoop reinforcement or even in the lower sidewall, for example in the bead.

In an embodiment which has not been illustrated, each reinforcing element is a filamentary element made up of a metallic monofilament. The metallic monofilament then has a diameter in the range from 0.10 mm to 0.40 mm.

In an embodiment which has not been illustrated, each reinforcing element is a filamentary reinforcing element made up of two textile multifilament strands wound around one another.

It will also be possible to combine the characteristics of the various embodiments described or envisaged above, with the proviso that these characteristics are compatible with one another.

1-28. (canceled)

29. A tire comprising a reinforcing assembly, wherein the reinforcing assembly includes:
a knit having a right side and a wrong side; and
a plurality of reinforcing elements that extend parallel to one another,
wherein each of the reinforcing elements criss-cross the knit over at least a portion of the knit, and
wherein the knit is arranged such that the right side of the knit is positioned radially outside relative to the wrong side of the knit.

30. The tire according to claim 29,
wherein the knit includes:
a plurality of columns of loops, with loops of a same column being arranged one after another substantially overall in a main direction (X1) of the knit, and
a plurality of rows of loops, with loops of a same row being arranged one beside another substantially overall in a transverse direction (Z1) of the knit, and
wherein each of the reinforcing element extends substantially overall in the main direction or in the transverse direction.

31. The tire according to claim 29,
wherein each of the reinforcing elements is a filamentary element that includes at least one multifilament strand formed of a plurality of elementary monofilaments, and
wherein each of the elementary monofilaments is made from a metallic material, or a textile material, or both a metallic material and a textile material.

32. The tire according to claim 30,
wherein each of the reinforcing elements is a filamentary element that includes at least one multifilament strand formed of a plurality of elementary monofilaments, and
wherein each of the elementary monofilaments is made from a metallic material, or a textile material, or both a metallic material and a textile material.

33. The tire according to claim 29, wherein each of the reinforcing elements is a filamentary element formed of a metallic monofilament.

34. The tire according to claim 30, wherein each of the reinforcing elements is a filamentary element formed of a metallic monofilament.

35. The tire according to claim 29, further comprising:
a crown;
a tread surmounting the crown;
two sidewalls;
two beads;
a carcass reinforcement; and
a crown reinforcement,
wherein the two sidewalls connect the two beads to the crown, respectively,
wherein the carcass reinforcement is anchored in each of the beads and extends through the sidewalls towards the crown,
wherein the crown reinforcement is radially interposed between the carcass reinforcement and the tread, and
wherein the reinforcing assembly is included in the crown reinforcement.

36. The tire according to claim 35, wherein the crown reinforcement includes a working reinforcement that includes a plurality of working plies.

37. The tire according to claim 36, wherein each of the working plies includes working reinforcing elements that form an angle in a range of from 15° to 40° with a circumferential direction of the tire.

38. The tire according to claim 37, wherein the working reinforcing elements are crossed from one of the working plies to another of the working plies.

39. The tire according to claim 37, wherein at least one of the working plies includes the reinforcing assembly, with the reinforcing elements of the reinforcing assembly forming the working reinforcing elements of the at least one of the working plies.

40. The tire according to claim 39,
wherein the reinforcing assembly is one of a plurality of reinforcing assemblies of the tire, and
wherein each of the working plies includes a corresponding one of the reinforcing assemblies, with the reinforcing elements of each of the reinforcing assemblies forming the working reinforcing elements of a corresponding one of the working plies.

41. The tire according to claim 35, wherein the crown reinforcement includes:
a working reinforcement that includes a plurality of working plies, and
a protective reinforcement that includes a protective ply.

42. The tire according to claim 41,
wherein each of the working plies includes working reinforcing elements that form an angle in a range of from 15° to 40° with a circumferential direction of the tire, and
wherein the protective ply includes protective reinforcing elements that form an angle in a range of from 5° to 35° with the circumferential direction of the tire.

43. The tire according to claim 42, wherein the working reinforcing elements are crossed from one of the working plies to another of the working plies.

44. The tire according to claim 42, wherein the protective ply includes the reinforcing assembly, with the reinforcing elements of the reinforcing assembly forming the protective reinforcing elements of the protective ply.

45. The tire according to claim 42, wherein at least one of the working plies includes the reinforcing assembly, with the reinforcing elements of the reinforcing assembly forming the working reinforcing elements of the at least one of the working plies.

46. The tire according to claim 45,
wherein the reinforcing assembly is one of a plurality of reinforcing assemblies in the tire, and
wherein each of the working plies includes a corresponding one of the reinforcing assemblies, the reinforcing elements of each of the reinforcing assemblies forming the working reinforcing elements of a corresponding one of the working plies.

47. The tire according to claim 41, wherein the protective ply is interposed radially between two of the working plies.

48. The tire according to claim 41, wherein the protective ply is interposed radially between the tread and the working reinforcement.

49. A method of reinforcing a tire, the method comprising incorporating a reinforcing assembly in the tire, the reinforcing assembly including:
a knit having a right side and a wrong side; and
a plurality of reinforcing elements that extend parallel to one another,
wherein each of the reinforcing elements criss-cross the knit over at least a portion of the knit, and
wherein the knit is arranged such that the right side of the knit is positioned radially outside relative to the wrong side of the knit.

50. A method of manufacturing a tire, the method comprising:
obtaining a reinforcing assembly that includes:
a knit having a right side and a wrong side, and
a plurality of reinforcing elements that extend parallel to one another,
wherein each of the reinforcing elements criss-cross the knit over at least a portion of the knit, and
wherein the knit is arranged such that the right side of the knit is positioned radially outside relative to the wrong side of the knit; and
embedding the reinforcing assembly in a matrix of at least one elastomer.
